(19) United States
(12) Patent Application Publication
(10) Pub. No.: US 2023/0339690 A1
(43) Pub. Date: Oct. 26, 2023

(54) IMPROVEMENTS IN OR IN RELATION TO SUGARCANE PROCESSING

(71) Applicant: Alan Lewis Fitzmaurice, Brisbane (AU)

(72) Inventor: Alan Lewis Fitzmaurice, Brisbane (AU)

(21) Appl. No.: 18/024,757

(22) PCT Filed: Sep. 8, 2021
(86) PCT No.: PCT/AU2021/051040

§ 371 Date: Mar. 4, 2023

(30) Foreign Application Priority Data
Sep. 8, 2020 (AU) 2020903216

(51) Int. Cl. B65G 21/20; B65G 15/44; B65G 15/24

(52) U.S. Cl. CPC B65G 21/20; B65G 15/44; B65G 15/24; B65G 2201/0202; B65G 2207/26

(57) ABSTRACT

A slotted conveyor floor 16 in milling tandem, slots 34 extend across the direction of liquid flow shown by arrow 35 which is against the flow of fibre. The slots are cut through the material of floor 16 on the vertical as depicted by centre-line 35 taken relative to the inclination of floor 16. Thus the centre-line corresponds to gravity feed for the liquid. Rather than being directly across the floor 16, the slots are inclined in the direction of flow. The fibre is in the opposite flow relation to the liquid, in this example, the slots are across the line of the fibre and are about 6 mm wide and 180 mm long with about 60 mm spacing. Adjacent lines of slots are set interdigital in the direction of travel. This arrangement minimises fibre being trapped in the slots as the fibre is being carried by the rakes up the floor.

### TECHNICAL FIELD

THIS INVENTION relates to improvements in or in relation to sugarcane processing and in particular but not limited to an improved conveyor floor to aid the capture of juice with less included fibre and more particularly but not limited to a conveyor floor for use with a conventional rake elevator or the like. This improvement enhances the washing of pol out of bagasse on the conveyor floor.

### BACKGROUND

Sugar cane is the world's largest crop and is grown mostly in tropical regions with high rainfall. Brazil is by far the highest cane producer. It is believed that cultivation first started in India in 327 BC but may have been as early as 8000 BC. Sugar cane was harvested by hand until the first Massey Ferguson chopper harvester was produced in 1958 at Ingham in Queensland, Australia. Upon arrival at the factory, the unwashed cane is cut and crushed to remove the juice. This can involve multiple repeated maceration and pressing stages resulting in relatively dry bagasse. However, there will still be a small amount of juice in the bagasse depending on the overall mill efficiency.

Small efficiencies may result in large gains over time.

However, the Applicant has recognised that particular combinations of features may give unexpected benefits in terms of efficiencies. The applicant has considered the operation of existing milling tandems and looked at how he might make changes that may give rise to an overall increase in mill efficiency.

Conventional milling tandems employ inter-mill conveyors to move shredded and crushed cane fibre between mills.

As the cane is being conveyed water is first added to fibre on the inter-mill conveyor before the final mill. Liquid including this water is drained from the final mill and this drained liquid is then pumped upstream to other inter-mill conveyors in the tandem. Thus the initial water will be used to flush juice progressively cycled mill-by-mill gradually back to the first mill where it is finally collected and pumped to process. About 75% of the juice is separated and collected at the first mill. Much of the remaining juice is collected by this imbibition and maceration process in the following mills.

There are a very large number of patents dealing with juice extraction using shredding followed by pressure. A non-exhaustive and fairly random list spread over time is given as follows: WO2019/095001, WO93/16794, U.S. Pat. Nos. 5,772,775, 5,073,200, 4,644,716, 4,543,129, 4,043,832, 3,827,909, 3,661,082, 3,100,725, AU2013204686.

These and the others should be referred to in order to demonstrate that in all the circumstances the notional skilled person would be presented with many similar solutions in an old, mature and crowded art, yet Applicant's invention escaped the skilled person over these many years. Since the present invention arises in a crowded art it would be prima facie wrong to suggest that there was, or is, a particular problem or motivation extant at the filing date of the present application that would give rise to the non-inventive notional person coming up with the present invention either in its idea, its concept or its practical form. Thus the recognition and the present conception may be considered as whole or part of the Applicant's inventive step.

With this and the other background factors, including those set out above, in mind, it should be clearly appreciated to the reader, that it is elementary that exercise of the inventive faculty in all the circumstances, in such a crowded art, is likely to be present in small variations. This is particularly the case in the sugar industry where small increases in efficiency will reap large economic benefits over time. This is a background observation in hindsight only and is not to say that any of Applicant's new features whether individually or in combination are in any way slight or small.

Even though the art has become crowded, according to the Applicant's understanding of the marketplace, to the extent there have been many offerings, they have been widely accepted in the field of cane harvesting and processing.

Consequently, there is a requirement for a fresh look “outside the box” through new eyes in an effort to provide an alternative to the efforts made over the last many years. It would be desirable to have something that is simple and easy to assemble, yet effective, but employing common techniques and methods to arrive at a new and useful combination and result. Simplicity is not considered a bar to there being an invention, but in a crowded art, simplicity may indeed actually be an indicator of invention. In sugar production the improvements have to be more and more ingenious to make these gains.

This means that the present invention does not arise through any deterministic relationship to the prior art. Rather it is the inventor's own inspiration in an individualistic way applying the inventor's mind to the general state of the art and to the inventor's knowledge and recognition of defects arising including during his prototyping and development that might be remedied, this being as an alternative to what is currently available, rather than an effort to deal with any specific generally recognised real extant problem common at the time, or any notional problem derived ex post facto, from any single item of the prior art, selected by hindsight, from a clearly crowded art. In these circumstances, any selection in a crowded art must necessarily be based on Applicant's disclosure as the starting point. Selection of features from what are otherwise workable solutions to match Applicant's claims must necessarily involve a rejection of other features from the combinations disclosed in those solutions.

### Outline

In one aspect there is provided, in a sugar mill having at least one inclined conveyor having a lower end and an upper end and a direction of travel, the conveyor being set above an inclined conveyor floor running along and under the conveyor, the conveyor floor being perforated or having spaced slots extending across the conveyor floor, the perforations or slots having a hydraulic efficiency defined by walls of the perforations or slots being set to promote juice flow while inhibiting fibre clogging. Preferably, the perforations or slots are set substantially vertical. In the present application, the invention occupies the range of variation between perforations to spaced slots as long as the juice to fibre filtration effect means that fibre clogging of the floor and passage through the floor is inhibited as fibre moves up along the floor and this by typically substantially vertical configuration of the perforations or slots as fibre travels up the conveyor along the floor in the direction of travel and juice travels down and through the perforations or slots in the conveyor floor.

In another aspect there is provided a conveyor floor in a sugar mill, the conveyor floor having spaced juice flow-through slots, the slots being set to have a widest cross-section when viewed vertically in order to promote flow through the slots.

The slots preferably extend across and down the floor in order to promote movement of fibre along the floor and inhibit fibre passing through the slots or clogging the slots.

The slots may be straight or non-straight. The slots may be any shape. Typically, the slots are about 6 mm wide, 180 mm long and about 60 mm apart in an ordered pattern but need not be in any particular pattern. The slots may have a general V-pattern. The slots may be set in an alternating pattern with ends of adjacent slots being interdigital and offset along the floor in the direction of travel. Thus there may be multiple rows of slots extending in the direction of travel.

In another aspect there is provided an improved milling tandem of the type having at least two inter-mill conveyors with fibre moving up along the conveyors in a downstream direction, the improvement comprising:
(i) a pressure feeder downstream and fed by a said conveyor, the pressure feeder leading into mill rolls;
(ii) juice from the pressure feeder being delivered to the lower end of a conveyor upstream of the pressure feeder;
(iii) juice from mill rolls following the said pressure feeder being combined with juice from further downstream and the combined juice also being fed to the lower end of the conveyor referred to in (ii).
(iv) each of the said conveyors having a slotted conveyor floor adapted to promote juice flow through the floor while inhibiting fibre passage through the floor.

In each of the above aspects the conveyor may have tines, paddles, rakes or the like spaced along the conveyor and typically these travel in closely spaced relation to the slotted floor.

In a preferred form Applicant has devised a method and apparatus to improve juice separation for fibre particularly suited to the inter-mill conveyors.

Preferably, in (ii) juice from the pressure feeder attached to a preceding mill is delivered to a weir at a lower end of a conveyor leading to the preceding mill.

Preferably, in (iii) juice from the mill rolls following the pressure feeder are combined with juice drained from a drainage tray under the conveyor which is pumped to a second weir on the conveyor preceding the mill directly in front and upstream.

Preferably, in (iv) each conveyor has a slotted conveyor floor adapted to promote juice flow through the floor while inhibiting fibre passage through the floor.

Preferably, In each of the above aspects the conveyor may have rakes accompanying the tines.

Thus there may be provided in a preferred form and separately of the sugar mill a slotted anti-dog conveyor floor for use in a sugar factory, the floor having a liquid flow direction and spaced apart anti-clog slots extending downstream and laterally across the floor. The anti-clog slots are typically vertically oriented when the floor is in its operative position for liquid falling freely through the slots under the influence of gravity. In one example the anti-clog slots are vertically walled slots when the floor is in its operative position. The slots may be cut through the floor along a centre-line inclined to the plane of the floor in the region of the floor adjacent to the said slot. The slots may be arranged in rows. The slots may be evenly spaced. Adjacent slots may be set in interdigital relation across the floor.

In further preferred form there is provided a milling tandem having five mills; each mill has six rolls; with fibre moving from a first mill through to an outlet downstream of the fifth mill; each mill having a pressure feeder followed by mill rolls, intermill conveyors comprising rake elevators; at least one of the elevators having a said conveyor floor.

### BRIEF DESCRIPTION OF THE DRAWINGS

In order that the present invention may be more readily understood and be put into practical effect, reference will now be made to the accompanying drawings which illustrate a preferred embodiment of the invention and wherein:—

FIGS. 1A and 1B together illustrate a schematic of a five mill tandem sugar mill incorporating the present invention;

FIG. 2 is an enlarged schematic of part of the milling tandem of FIGS. 1A and 1B;

FIG. 3 is a further enlargement side section of a conveyor floor used in the present invention approximating the section 3-3 of FIG. 4; and

FIG. 4 is a top view of a slotted conveyor floor pattern applied to the present invention and corresponding to the section of FIG. 3.

### METHOD OF PERFORMANCE

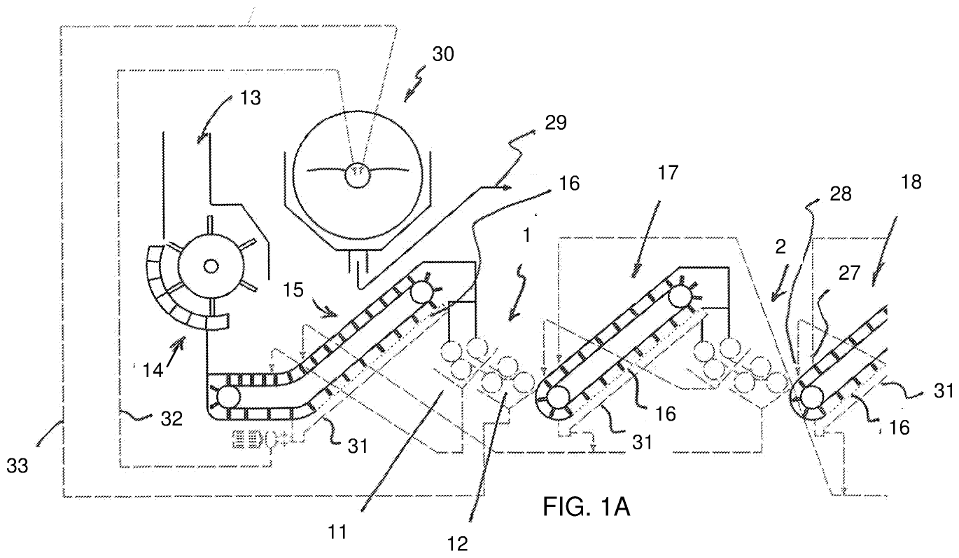

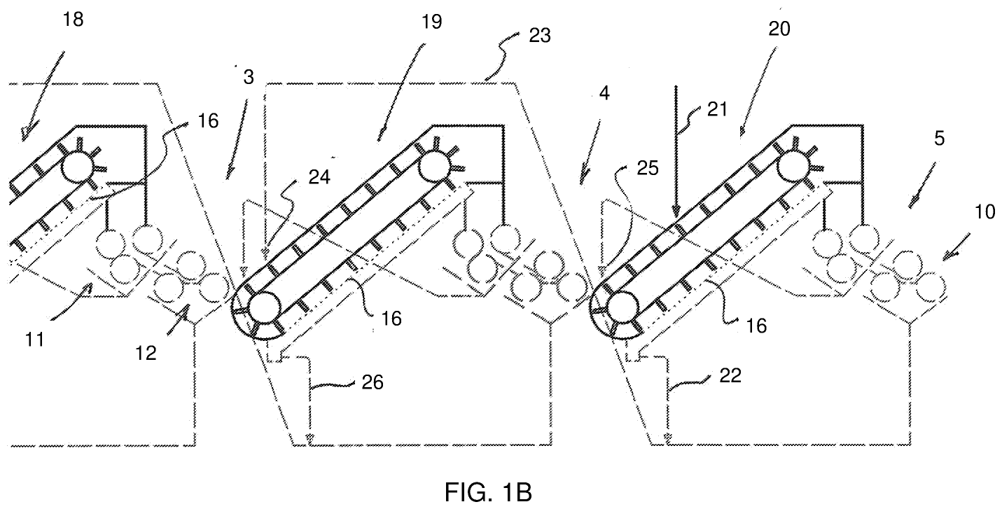

Referring to FIGS. 1A and 1B, FIG. 1B is to an enlarged scale, and is a continuation of FIG. 1A. This means FIGS. 1A and 1B together represent a milling tandem. In this case, there are five mills, each mill has six rolls; thus there is a mill 1 through 5 illustrated. The number of mills in the tandem may vary as may the form of each mill. Relatively dry bagasse exits mill 5 at a downstream end at 10. Each mill has a pressure feeder at 11 followed by mill rolls at 12. The portion shown in the solid outline may be considered generally conventional. The conveyors may be conventional rake elevators. The dotted portions in FIGS. 1A and 1B correspond, in combination with conventional elements, to a preferred form of an improved mill according to the present invention.

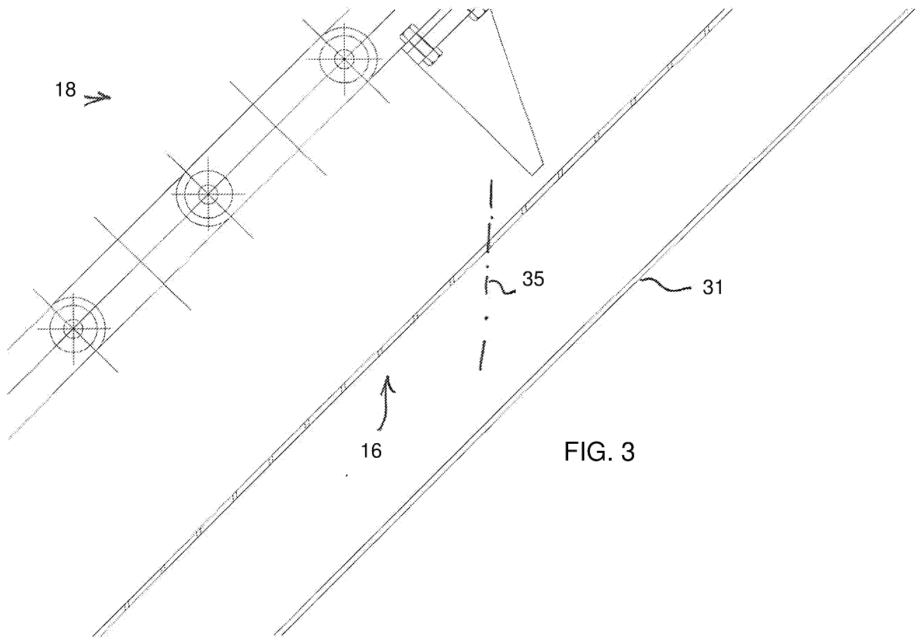

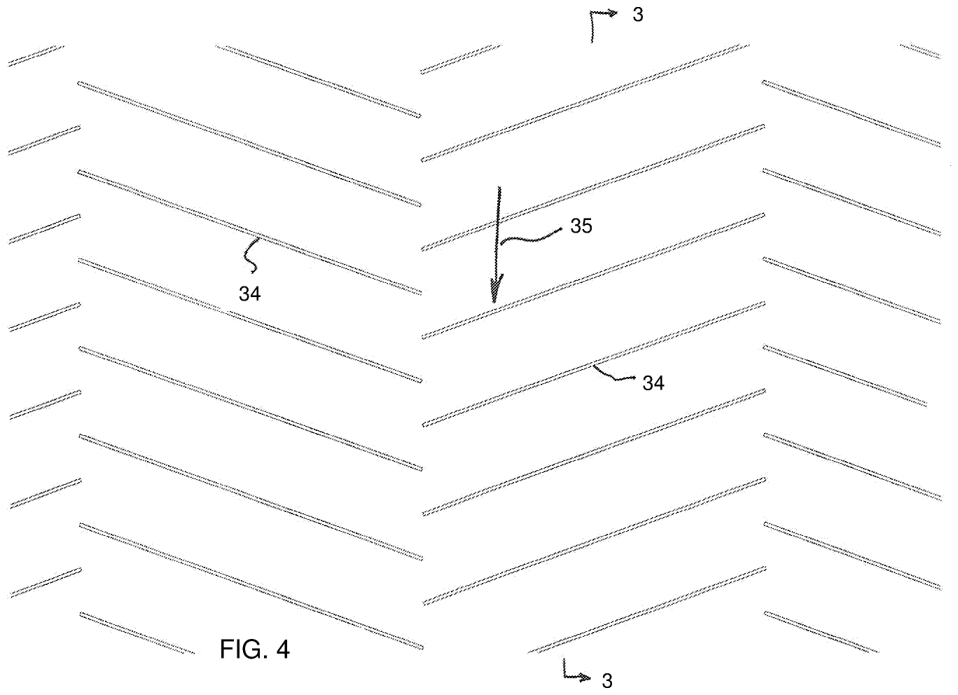

Thus there is at an upstream end, a conventional feed chute 13 leading to a shredder 14 and then on to a first conveyor 15. Dotted is an improved conveyor floor at 16. This form of conveyor floor is repeated at each inter-mill conveyor 17, 18, 19 and 20 and will be described further in relation to FIGS. 3 and 4. Fibre is moved upward along this floor. Low pol juice is delivered at the lower end of each conveyor via pairs of weirs as will be described below.

In use the various liquid flows between the mills are depicted in the long dash lines in FIGS. 1A and 1B, The liquid generally travels in the opposite direction to the fibre.

Water is initially delivered at 21 on to fibre carried on conveyor 20 to macerate the fibre prior to the final mill. Subsequent low pol liquid flows through the conveyor floor 16 in the final conveyor and is collected via a drainage tray to flow along line 22. This liquid is combined with liquid from the fifth mill, mill rolls 10, and together this liquid is delivered to conveyor 19 of the second last mill along line 23 via an upstream weir at 24 where it is spread over fibre entering onto the floor 16 of conveyor 19.

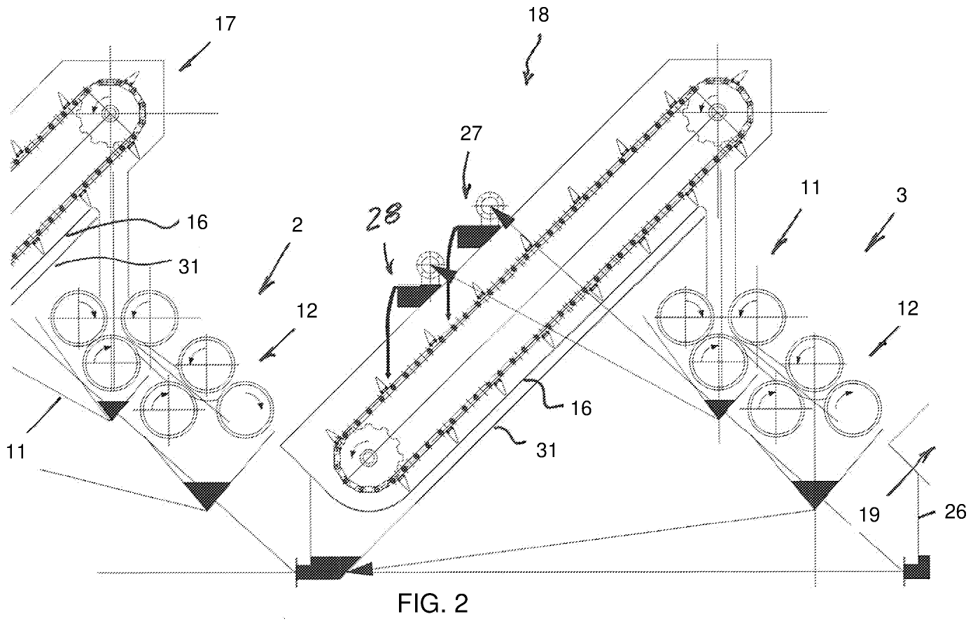

Liquid collected from the pressure feeder 11 of mill 5 is fed to the bottom end of the conveyor 20 to a weir at 25 which flows onto fibre moving onto floor 16 of the conveyor 20. This process effectively repeats for mill 4 and conveyor 19 except there are two weirs. Liquid passing through the conveyor floor 16 of conveyor 19 flows along line 26 where that liquid is combined with liquid from the mill rolls of mill 4 and is delivered to a slightly upstream weir 27 of conveyor 18. It is applied over the fibre on the floor of conveyor 18. Liquid from the pressure feeder of mill 4 is applied to an upstream weir at 28 just below the weir 27. The weirs deliver liquid as near as practicable to the lower end of the conveyors to increase maceration time. In FIG. 2 they are slightly higher than shown in FIGS. 1A and 1B.

This process is repeated again for conveyors 16 and 17 and mills 1 and 2. Ultimately, the juice is delivered to process along line 29 via a rotary juice screen assembly 30 after being collected from the conveyor 15 through drainage tray 31 and the first mill roll set at 12 and along lines 32 and 33. The preceding description outlines the basic operation of the mill.

Important conveyor details are in FIGS. 3 and 4 which show the slotted conveyor floor used at 16.

Slots 34 in the pattern shown in FIG. 4 extend across the direction of liquid flow shown by arrow 35. The slots are cut through the material of floor 16 on the vertical as depicted in FIG. 3 by centre-line 35 taken relative to the inclination of floor 16. Thus the centre-line corresponds to gravity feed for the liquid. Rather than being directly across the floor 16, the slots are inclined in the direction of flow. The fibre is in the opposite flow relation to the liquid. In this example, the slots are across the line of the fibre and are about 6 mm wide and 180 mm long with about 60 mm spacing. Adjacent lines of slots are set interdigital in the direction of travel. This arrangement minimises fibre being trapped in the slots as the fibre is being carried by the rakes up the floor.

The vertical or gravity preferred cut improves hydraulic efficiency while the inclination in the flow direction and the narrow slots improves fibre filtration while also promoting the continued movement of fibre above and across the slots along the floor 16 rather than through the slots and also at the same time inhibiting fibre from blocking the slots.

Whilst the above has been given by way of illustrative example many variations and modifications will be apparent to those skilled in the art without departing from the broad ambit and scope of the invention as herein set out in the appended claims.

What is claimed is:

1. A slotted anti-clog conveyor floor for use in a sugar factory, the floor having a liquid flow direction and spaced apart anti-clog slots extending downstream and laterally across the floor.

2. A slotted anti-clog conveyor floor according to claim 1, the anti-clog slots being vertically oriented when the floor is in its operative position for liquid falling freely through the slots under the influence of gravity.

3. A slotted anti-clog conveyor floor according to claim 1, the anti-clog slots comprising vertically walled slots when the floor is in its operative position.

4. A slotted anti-clog conveyor floor according to claim 1 wherein the slots are cut through the floor along a centre-line inclined to the plane of the floor in the region of the floor adjacent the said slot.

5. A slotted anti-clog conveyor floor according to claim 1 wherein the slots are arranged in rows.

6. A slotted anti-clog conveyor floor according to claim 1 wherein the slots are evenly spaced.

7. A slotted anti-clog conveyor floor according to claim 1 wherein adjacent slots are set in interdigital relation across the floor.

8. A sugar mill having at least one inclined conveyor having a lower end and an upper end and a direction of travel for movement of fibre from the lower end to the upper end, the conveyor being set above an inclined conveyor floor running along and under the conveyor, the conveyor floor being perforated or having spaced slots extending across the conveyor floor, the perforations or slots having a hydraulic efficiency for liquid falling freely through the slots under the influence of gravity.

9. A sugar mill according to claim 8 wherein the hydraulic efficiency is defined by walls of the perforations or slots being set to promote juice flow while inhibiting fibre clogging.

10. A sugar mill according to claim 8 wherein the perforations or slots are set substantially vertical.

11. A sugar mill according to claim 8 wherein the slots are set to have a widest cross-section when viewed vertically in order to promote flow through the slots.

12. A sugar mill according to claim 8 wherein the slots extend across and down the floor in order to promote movement of fibre along the floor and inhibit fibre passing through the slots or clogging the slots.

13. A sugar mill according to claim 8 comprising a milling tandem of the type having at least two inter-mill conveyors with fibre moving up along the conveyors in a downstream direction, the improvement comprising:
(i) a pressure feeder downstream and fed by a said conveyor, the pressure feeder leading into mill rolls;
(ii) juice from the pressure feeder being delivered to the lower end of a conveyor upstream of the pressure feeder;
(iii) juice from mill rolls following the said pressure feeder being combined with juice from further downstream and the combined juice also being fed to the lower end of the conveyor referred to in (ii);
(iv) at least one of the said conveyors having a said conveyor floor adapted to promote juice flow through the floor while inhibiting fibre passage through the floor.

14. A sugar mill according to claim 8 wherein the conveyor has tines, paddles, or rakes spaced along the conveyor and these travel in closely spaced relation to the floor.

15. A sugar mill according to claim 8 wherein each inter-mill conveyor comprises a said floor.

16. A sugar mill according to claim 8 wherein, in (ii), juice from the said pressure feeder attached to a said preceding mill is delivered to a weir at a lower end of a said conveyor leading to the preceding mill.

17. A sugar mill according to claim 8 wherein, in (iii) juice from the mill rolls following the pressure feeder are combined with juice drained from a drainage tray under the conveyor which juice is pumped to a second weir on the conveyor preceding the mill directly in front and upstream.

18. A sugar mill according to claim 8 wherein, in (iv) each conveyor has a slotted conveyor floor adapted to promote juice flow through the floor while inhibiting fibre passage through the floor.

19. A sugar mill according to claim 8 wherein the floor comprises a slotted anti-clog conveyor floor having a liquid flow direction and spaced apart anti-clog slots extending downstream and laterally across the floor.

20. A sugar mill according to claim 8 comprising a milling tandem having five mills, each mill has six rolls, with fibre moving from a first mill through to an outlet downstream of the fifth mill, each mill having a pressure feeder followed by mill rolls, intermill conveyors comprising rake elevators, at least one of the elevators having a said conveyor floor.
